(19) United States
(12) Patent Application Publication
(10) Pub. No.: US 2018/0078796 A1
(43) Pub. Date: Mar. 22, 2018

(54) PROTECTIVE MASK

(71) Applicant: KOKEN LTD., Chiyoda-ku, Tokyo (JP)

(72) Inventor: Hironobu TAKEUCHI, Chiyoda-ku, Tokyo (JP)

(21) Appl. No.: 15/559,417

(22) PCT Filed: Feb. 10, 2016
(86) PCT No.: PCT/JP2016/053891

§ 371 Date: Sep. 18, 2017

(30) Foreign Application Priority Data
Mar. 19, 2015 (JP) 2015-056127

(51) Int. Cl. A62B 18/02; A62B 18/08; A62D 7/00

(52) U.S. Cl. CPC A62B 18/02; A62D 7/00; A62B 18/082; A62B 18/084

(57) ABSTRACT

Provided is a protective mask that is highly comfortable to wear. A protective mask includes: a face piece; an eyepiece attached to the face piece; and a lip extending from an outer circumference of the face piece in a direction crossing the face piece, in which at least a part of the lip includes a face contact portion capable of coming into contact with a face of a wearer, the face contact portion is formed from a silicone rubber, the face piece and the lip are formed from a gas impermeable material except for the face contact portion, and the gas impermeable material and the silicone rubber are joined together along the boundary between the gas impermeable material and the silicone rubber.

### RELATED APPLICATIONS

The present application is a National Phase of International Application Number PCT/JP2016/053891, filed Feb. 10, 2016, which claims priority to Japanese Application Number 2015-056127, filed Mar. 19, 2015.

### TECHNICAL FIELD

The present invention relates to a protective mask and more particularly relates to a protective mask that is highly comfortable to wear.

### BACKGROUND ART

Full-face protective masks have been known. Patent Literature 1 discloses an example of a full-face mask including: a face part (also referred to as a face piece) that comes into contact with the face of a wearer; and an eye glass part (also referred to as an eyepiece) formed from a transparent material, ensuring visibility of the wearer. The face piece in Patent Literature 1 includes a face contact portion that is formed from synthetic rubber and can be elastically flexible. The face contact portion is elastically flexible to conform to the contour of the face of the wearer when the protective mask is worn. Thus, an airtight state is achieved between the face of the wearer and the face contact portion.

### CITATION LIST

### Patent Literature

PTL 1: Japanese Unexamined Patent Application Publication No. 2012-10731 (JP2012-10731A)

### SUMMARY OF INVENTION

### Technical Problem

Vulcanized rubber has been widely used as the synthesis rubber in the material of the face piece of the full-face protective mask. Generally, vulcanized rubber is irritative to the skin of a wearer and has high rubber hardness, and thus is uncomfortable to wear. Silicone rubber is not very irritative to the skin of a wearer, features high elasticity because of low rubber hardness, and thus has been known to achieve good wearing comfort. Silicone rubber also features high gas permeability, which feature is considered unsuitable for the material of the face piece of the protective mask that is required to offer high protection performance.

In view of the above, an object of the present invention is to provide a protective mask that is highly comfortable to wear.

### Solution to Problem

A protective mask according to the present invention includes: a face piece; an eyepiece attached to the face piece; and a lip extending from an outer circumference of the face piece in a direction crossing the face piece, in which at least a part of the lip includes a face contact portion capable of coming into contact with a face of a wearer, the face contact portion is formed from a silicone rubber, the face piece and the lip are formed from a gas impermeable material except for the face contact portion, and the gas impermeable material and the silicone rubber are joined together along the boundary between the gas impermeable material and the silicone rubber.

### Advantageous Effects of Invention

With the protective mask according to one or more embodiments of the present invention, the face piece is formed from a gas impermeable material, and a part in which silicone rubber is used is limited to the face contact portion. Thus, the face contact portion that is less irritating to the skin of a wearer can be provided without reducing the gas impermeability of the protective mask. With these configurations, a protective mask that is highly comfortable to wear can be provided.

### BRIEF DESCRIPTION OF DRAWINGS

The drawings illustrate specific embodiments of the present invention, including optional and preferred embodiments as well as essential features of the invention.

FIG. 1 is a perspective external view illustrating a protective mask according to the present invention.

FIG. 2(a) to FIG. 2(i) are cross-section views along line II-II in FIG. 1.

### DESCRIPTION OF EMBODIMENTS

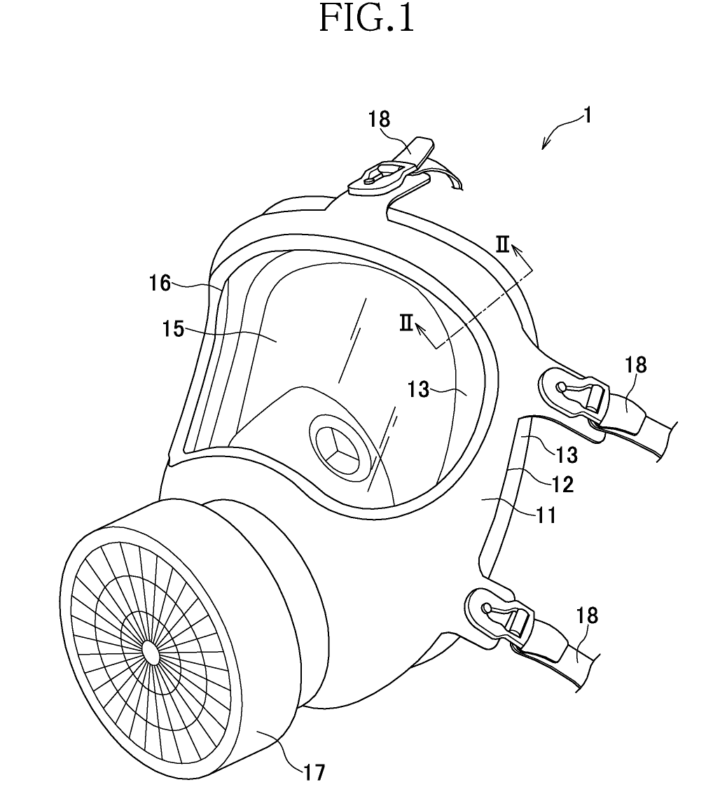

A protective mask 1 according to the present invention is described below with reference to the attached drawings. The protective mask 1 illustrated in FIG. 1 includes: a face piece 11 that covers the face of a wearer; a transparent eyepiece 15 attached to the face piece 11; and a lip 13 provided over the entire circumference of an outer circumference 12 of the face piece 11. The lip 13 has an annular shape conforming to the contour of the face. The lip 13 is partially or entirely provided with a face contact portion 14. The face contact portion 14 is provided over the entire circumference of the lip 13, and can be in airtight contact with the face of the wearer when the protective mask 1 is used. The protective mask 1 further includes: a canister 17 for removing toxic substances; and an attachment 18 for ensuring close contact between the protective mask 1 and the face of the wearer. The shapes of the canister 17 and the attachment 18 can be designed as appropriate, and are not limited to the illustrated examples.

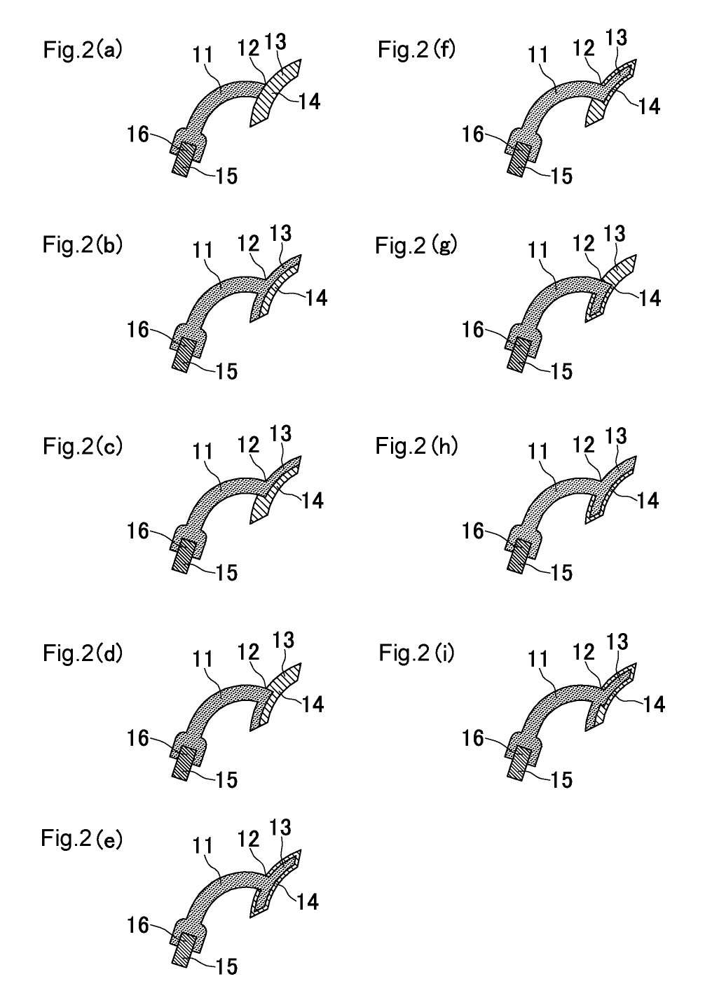

The face piece 11 is formed from a gas impermeable material. The face contact portion 14 is formed from silicone rubber. The eyepiece 15 is formed from a transparent material. The lip 13 is partially or entirely provided with the face contact portion 14 formed from silicone rubber. The lip 13 partially provided with the face contact portion 14 (that is, silicone rubber) has a portion other than the face contact portion 14 formed from a gas impermeable material. FIG. 2(a) to FIG. 2(i) are cross-section views of the protective mask 1 schematically illustrating various joining modes of the eyepiece 15, the face piece 11, the lip 13, and the face contact portion 14. In FIG. 2(a) to FIG. 2(i), a dotted portion represents a portion formed from the gas impermeable material, a hatched portion represents a portion formed from silicone rubber (that is, the face contact portion 14), and a hatched portion with more lines than in the face contact portion 14 represents a portion formed from the transparent material (that is, the eyepiece 15).

As illustrated in FIG. 2(a) to FIG. 2(i), the lip 13 extends in a direction crossing the face piece 11 from the outer circumference 12 of the face piece 11. In the illustrated example, the lip 13 extends in two directions toward the inner and outer sides of the protective mask 1 from the face piece 11, but may extend in only one of the directions instead. The face contact portion 14 is disposed on at least a surface of the lip 13 facing the face of the wearer. In other words, silicone rubber is definitely provided on the surface of the lip 13 facing the face of the wearer. Silicone rubber may also be provided at a position not facing the face of the wearer. For example, as illustrated in FIG. 2(a), the lip 13 may be entirely formed of silicone rubber. As illustrated in FIGS. 2(b) to 2(i), the lip 13 may be formed from a gas impermeable material and silicone rubber, with silicone rubber provided on one or both surfaces of the gas impermeable material. More specifically, the gas impermeable material in the lip 13 may have a shape extending from the face piece 11 in the two direction toward the inner and the outer sides of the protective mask 1 (see FIGS. 2(b), 2(e), 2(h), and 2(i)), or may have a shape extending in only one of the directions (see FIGS. 2(c), 2(d), 2(f), and 2(g)). In any of the configurations, the gas impermeable material and silicone rubber are joined together along the boundary between the gas impermeable material and silicone rubber. As used herein, the term “joining” refers to chemical bonding between the gas impermeable material and silicone rubber. For example, the chemical bonding can be achieved with polymer chains of silicone rubber and polymer chains of the gas impermeable material directly or indirectly bonded to each other through covalent bonding, along the boundary between the gas impermeable material and silicone rubber. The covalent bonding with the polymer chains of the gas impermeable material can be achieved with additive or condensation reaction. However, this should not be construed in a limiting sense. A physical supporting structure may also be provided to achieve higher bond strength. The structure is achieved with the shape of the boundary surface between the gas impermeable material and silicone rubber designed in such a manner as to enable easy fitting of one to the other or with the boundary surface provided with multiple micro recesses and protrusions to have a larger surface area. The joining between the gas impermeable material and silicone rubber is not limited to a specific structure. For example, the gas impermeable material and silicone rubber may be integrally molded to be joined together. The integral molding can be performed with double molding (so called two-color molding) or with insert molding.

In the examples illustrated in FIG. 2(a) to FIG. 2(i), the portion of the protective mask 1 formed from silicone rubber is limited to the face contact portion 14. Thus, the face contact portion 14 that is less irritating to the skin of a wearer can be provided without reducing the gas impermeability of the protective mask 1. In preferable examples illustrated in FIGS. 2(b) to 2(i), the lip 13 is formed from the gas impermeable material and silicone rubber, thin (for example, with a thickness of 0.5 to 3 mm) silicone rubber in the face contact portion 14 comes into contact with the face of the wearer, and the portion of the lip 13 formed from the gas impermeable material presses the silicone rubber against the face of the wearer. Silicone rubber features higher gas permeability than other synthetic rubber, directly related to a higher risk of being a route for toxic gas to flow into the protective mask 1. In view of this, silicone rubber is designed to be thin so that a smaller cross-sectional area of the route for the gas to spread inside the silicone rubber can be achieved. Furthermore, the lip 13 may be designed to extend from the face piece 11 for a long distance, so that a long gas dispersion path can be achieved. With these configurations, the gas impermeability of the protective mask 1 can be prevented from being reduced.

When the eyepiece 15 is attached to the face piece 11, the gas impermeable material forming the face piece 11 and the transparent material forming the eyepiece 15 are preferably joined together through integral molding. When the gas impermeable material and the transparent material are joined together through integral molding, the gas impermeable material and the transparent material are preferably chemically bonded to each other. In the protective mask 1 with a conventional configuration (see, for example, Patent Literature 1 described above), the eyepiece 15 is attached to the face piece 11 via an attachment frame. The attachment frame can be omitted without reducing the airtightness of the protective mask 1 when the transparent material forming the eyepiece 15 and the gas impermeable material forming the face piece 11 are joined together at the circumference 16 of the eyepiece 15 through integral molding, as illustrated in FIG. 2(a) to FIG. 2(i).

For example, the following materials may be used when the transparent material forming the eyepiece 15, the gas impermeable material forming the face piece 11 and a part of the lip 13, and the silicone rubber forming the face contact portion 14 are joined together.

Examples of the transparent material for forming the eyepiece 15 include urethane rubber, isoprene rubber, urethane resin, polycarbonate, and polyacetal, but are not limited to these. The transparent material forming the eyepiece 15 preferably has gas impermeability. The attachment frame can be omitted when the eyepiece 15 is attached to the face piece 11 by integral molding as described above. When the attachment frame is omitted, the height of the protective mask 1 can be reduced by folding the eyepiece 15, formed from the transparent material that is anyone of urethane rubber, isoprene rubber, and urethane rubber with flexibility. This can increase portability of the protective mask 1, and thus is preferable.

Examples of the gas impermeable material for forming the face piece 11 and the lip 13 include synthetic rubber, thermoplastic elastomer, and a mixture of these. Examples of the synthetic rubber usable in the present invention include isoprene rubber, butyl rubber, nitrile rubber, chloroprene rubber, acryl rubber, chlorosulfonated polyethylene rubber, urethane rubber, fluorine rubber, and epichlorohydrin rubber. Examples of the thermoplastic elastomer usable in the present invention include styrene, olefin, polyvinyl chloride, urethane, and amide thremoplastic elastomer. The silicone rubber used for forming the face contact portion 14 is not particularly limited, and examples of this include: one-pack type thermoset silicone rubber; and adhesive silicone rubber with a reactive group at the side chain or the end. The gas impermeable material used in the present invention may optionally include silicone rubber as long as the gas impermeability is not reduced. It is well known that sufficient join strength can be achieved with the type of the silicone rubber and the type of the impermeable material, such as urethane rubber, isoprene rubber, and urethane resin, appropriately selected.

The present invention is described on the basis of the embodiment. However, the present invention is not limited to the embodiment, and can be modified in various ways to be implemented. For example, the face piece 11 illustrated in FIG. 2(a) to FIG. 2(i) have a cross-sectional shape having a smooth curve. Alternatively, the face piece 11 may have a cross-sectional shape including a curve with a bent portion so that the face contact portion 14, provided to the lip 13, can be in close contact with the face of the wearer. In the illustrated example, the face contact portion 14 is provided entirely over the surface of the lip 13 facing the face of the wearer. Still, the scope of the present invention includes a configuration in which the face contact portion 14 is provided only partially on the surface of the lip 13 facing the face of the wearer, and the gas impermeable material is exposed at a portion without the face contact portion 14.

The disclosure of present invention described above related to the protective mask may be arranged with the following matters.

A protective mask including: a face piece; an eyepiece attached to the face piece; and a lip extending from an outer circumference of the face piece in a direction crossing the face piece, in which at least a part of the lip includes a face contact portion capable of coming into contact with a face of a wearer, the face contact portion is formed from a silicone rubber, the face piece and the lip are formed from a gas impermeable material except for the face contact portion, and the gas impermeable material and the silicone rubber are joined together along the boundary between the gas impermeable material and the silicone rubber.

The present invention disclosed in paragraph [0018] described above may include at least the following embodiments, which may be taken in isolation from or in combination with one another.
(1) The lip may include the gas impermeable material and the silicone rubber forming the face contact portion.
(2) The eyepiece may be formed from a transparent material selected from the group consisting of urethane rubber, isoprene rubber, and urethane resin, and the transparent material and the gas impermeable material in the face piece may be joined together at a circumference of the eyepiece.

1. A protective mask comprising:
a face piece;
an eyepiece attached to the face piece; and
a lip extending from an outer circumference of the face piece in a direction crossing the face piece, wherein
at least a part of the lip includes a face contact portion capable of coming into contact with a face of a wearer,
the face contact portion is formed from a silicone rubber,
the face piece and the lip are formed from a gas impermeable material except for the face contact portion, and
the gas impermeable material and the silicone rubber are joined together along the boundary between the gas impermeable material and the silicone rubber.

2. The protective mask according to claim 1, wherein
the eyepiece is formed from a transparent material selected from the group consisting of urethane rubber, isoprene rubber, and urethane resin, and
the transparent material and the gas impermeable material in the face piece are joined together at a circumference of the eyepiece.
